(19) United States
(12) Patent Application Publication
(10) Pub. No.: US 2011/0062285 A1
(43) Pub. Date: Mar. 17, 2011

(54) SYSTEM FOR SIMULTANEOUSLY MOVING SEVERAL ROWS OF SEATS IN A LONGITUDINAL DIRECTION

(75) Inventors: Mark Herzog, Barsbuttel (DE); Michael Dupont, Hamburg (DE); Michael Harriehausen, Hamburg (DE)

(73) Assignee: AIRBUS OPERATIONS GMBH, Hamburg (DE)

(21) Appl. No.: 12/865,268

(22) PCT Filed: Jan. 15, 2009
(86) PCT No.: PCT/EP09/50413

§ 371 Date: Nov. 29, 2010

Related U.S. Application Data
(60) Provisional application No. 61/063,031, filed on Jan. 31, 2008.

(30) Foreign Application Priority Data
Jan. 31, 2008 (DE) 10 2008 006 948.5

(51) Int. Cl. B64D 11/06

(52) U.S. Cl. 244/118.6

(57) ABSTRACT

According to an exemplary embodiment of the invention, a system for simultaneously longitudinally moving a plurality of selected seats or seat rows in an aircraft is stated, in which system a drive device for moving the seats is provided, wherein moving the seats takes place automatically according to a change in the seating configuration planning.

### CROSS-REFERENCE TO RELATED APPLICATIONS

This application claims the benefit of the filing date of German Patent Application No. 10 2008 006 948.5 filed 31 Jan. 2008 and of U.S. Provisional Patent Application No. 61/063,031 filed 31 Jan. 2008, the entire disclosure of which application is hereby incorporated herein by reference.

### FIELD OF THE INVENTION

The invention relates to the seating configuration in aircraft. In particular, the invention relates to a system for simultaneously longitudinally moving several selected seats or seat rows in an aircraft, to a seating arrangement in an aircraft, to the use of such a system in an aircraft, and to an aircraft comprising such a system.

### TECHNICAL FIELD

An aircraft has a particular seating layout (seating configuration) that is to be considered as being fixed and that is divided into 1, 2 or 3 classes.

Only reconfiguration makes it possible to change this layout, for example in order to provide a greater number of seat in a particular class. The classes can differ by different types of seats or merely by their seat pitch.

If only half of the seats in a flight are booked, it is nevertheless not possible to offer passengers improved comfort in the form of more space. Fast adaptation of the percentage distribution in the classes depending on the number of passengers on board is not possible either.

### SUMMARY OF THE INVENTION

It is an object of the invention to provide an automatic, individually adjustable seating configuration in an aircraft.

Stated are a system for simultaneously longitudinally moving a plurality of selected seats or seat rows in an aircraft, a seating arrangement, the use of such a system in an aircraft, and an aircraft according to the characteristics of the independent claims. Further embodiments of the invention are stated in the subordinate claims.

The described exemplary embodiments equally apply to the system, the seating arrangement, the use, and the aircraft.

According to an exemplary embodiment of the invention, a system for simultaneously longitudinally moving a plurality of selected seats or seat rows in an aircraft is stated, wherein the system comprises a drive device for moving the seats, and wherein the system is designed for automatically moving the seats according to a change in the seating configuration planning.

In other words it is possible, for example, to undertake changes in the seating configuration planning from outside the aircraft. These changes are, for example, entered or initiated by a passenger. This seating configuration planning is then communicated to the system so that the seats can correspondingly be automatically moved. The system thus makes possible quick automatic moving of several seat rows (or individual seats), depending on requirements. With this system several seat rows can simultaneously increase or decrease their seat pitch relative to each other.

According to a further exemplary embodiment of the invention, the system is designed as a mechanically coupled system. For example, all the seats or seat rows in question are mechanically coupled to the drive device, which subsequently moves all the seats simultaneously.

According to a further exemplary embodiment of the invention, the drive device comprises a scissor-type mechanism with a single drive for all the seats.

This single drive is, for example, affixed at the front (when viewed in the direction of the aircraft) of the scissor-type mechanism. The individual seats or seat rows are affixed at the nodal point in the scissor-type mechanism.

According to a further exemplary embodiment of the invention, the drive device is designed for simultaneously moving all the selected seats.

In this way the seat spacing can be changed quickly and effortlessly.

According to a further exemplary embodiment of the invention, the system is designed for self-contained individual moving of the selected seats or seat rows.

Individually selected seats can thus be moved individually, for example depending on the personal desire of individual passengers during booking.

According to a further exemplary embodiment of the invention, the drive device comprises a toothed rail that is fixed to the floor, and a drive motor for each seat row.

The drive motor in each seat row is, for example, coupled to a corresponding toothed wheel that engages the toothed rail or toothed rack. In this arrangement the toothed rail can be affixed to the passenger cabin floor or alternatively below the passenger cabin floor.

According to a further exemplary embodiment of the invention, the system further comprises a rotary speed sensor or a position sensor for each seat or for each seat row in order to determine the current longitudinal position of the corresponding seat or of the corresponding seat row.

In this way the system can detect the position of individual seats. Furthermore, each seat row can be individually controlled and moved. If necessary it is possible to carry out readjustments during the flight. For example, if a passenger would like to have more legroom available, a reconfiguration can be carried out.

According to a further exemplary embodiment of the invention, the system comprises an electronic control device for controlling the drive device.

This control device can, for example, be operated by the flight crew. Furthermore, the control device can be supplied with control data from outside the aircraft.

According to a further exemplary embodiment of the invention, the system comprises one or several separate seat rails for guiding the seats. Furthermore, a locking device for each seat is provided, which is used for locking or affixing the seat in the corresponding seat rail or seat rails.

In this way it can be ensured that no further seat movement can take place after the seat has been moved.

According to a further exemplary embodiment of the invention, the system further comprises an input unit for changing the seating configuration planning by a passenger, wherein the input unit can be arranged outside the aircraft and in this case is wirelessly coupled to the control device so that said input unit is able to communicate.

For example, at the time of booking, a passenger can enter how much legroom s/he wishes to have available. Prior to boarding, the seating adjustment is then carried out accordingly.

According to a further exemplary embodiment of the invention, a seating arrangement in an aircraft is stated that comprises a plurality of aircraft seats. Furthermore, the seating arrangement comprises a system as described above for simultaneously longitudinally moving the seats or seat rows.

According to a further exemplary embodiment of the invention, the use of a system as described above in an aircraft is stated.

According to a further exemplary embodiment of the invention, an aircraft comprising a system as described above is stated.

According to a further exemplary embodiment of the invention, a method for simultaneously longitudinally moving a plurality of selected seats or seat rows in an aircraft is stated, in which a seating configuration is planned, and subsequently simultaneous moving of the seats takes place according to a change in the seating configuration planning.

According to a further exemplary embodiment of the invention, additionally, transmission of the planned seating configuration from an input unit to a control unit, automatic release of the affixation of the seats prior to moving, and automatic affixation of the seats after moving take place.

Below, preferred exemplary embodiments of the invention are described with reference to the figures.

### SHORT DESCRIPTION OF THE FIGURES

FIG. 1 shows a diagrammatic view of two possible seating configurations in an aircraft.

FIG. 2 shows a diagrammatic view of further possible seating configurations including a user interface.

FIG. 3 shows a diagrammatic view of a first drive device according to an exemplary embodiment of the invention.

FIG. 4 shows a diagrammatic view of a second drive device according to an exemplary embodiment of the invention.

FIG. 5 shows a diagrammatic view of further possible seating configurations according to an exemplary embodiment of the invention.

### DETAILED DESCRIPTION OF THE EXEMPLARY EMBODIMENTS

The illustrations in the figures are diagrammatic and not to scale.

In the following description of the figures the same reference characters are used for identical or similar elements.

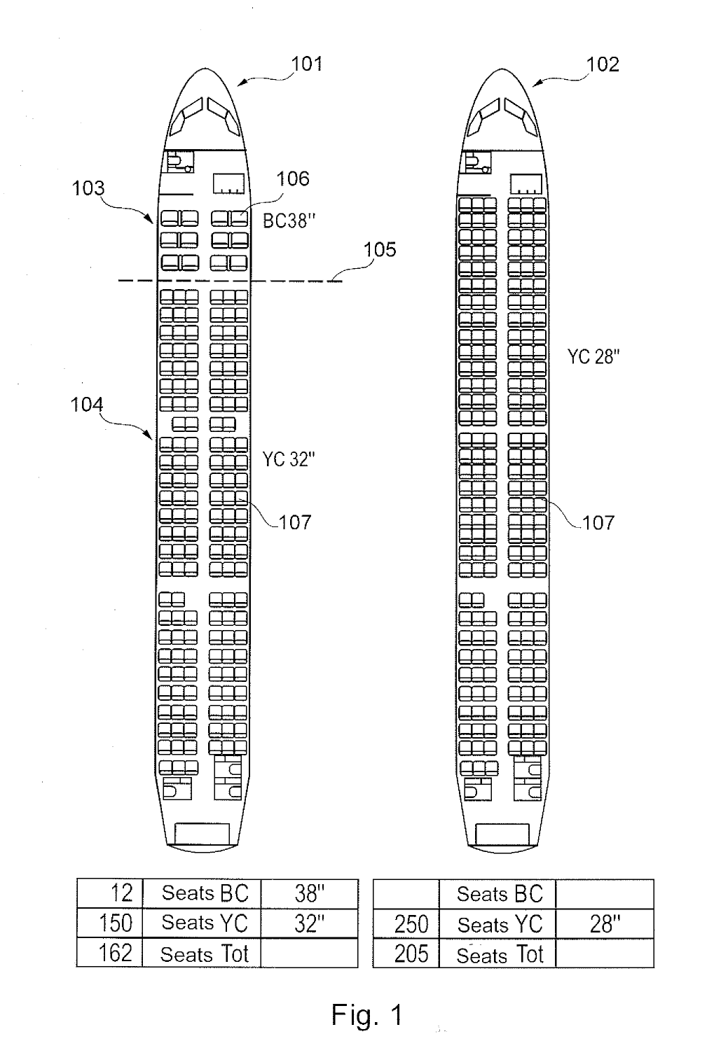

FIG. 1 shows a diagrammatic view of two seating configurations 101, 102 in an aircraft. In configuration 101 twelve seats 106 are provided in business class (BC) 103. There is a 38 inch seat pitch (which equates to approximately 96.5 cm).

The dashed line 105 indicates the separation of business class 103 from YC class 104. In the YC region 150 seats 107 are arranged with a 32 inch seat pitch (which equates to approximately 81 cm).

There are a total of 162 seats.

In configuration 102 all the seats are in YC class, in this case with a 28 inch seat pitch (which equates to approximately 71 cm). There are a total of 205 seats 107.

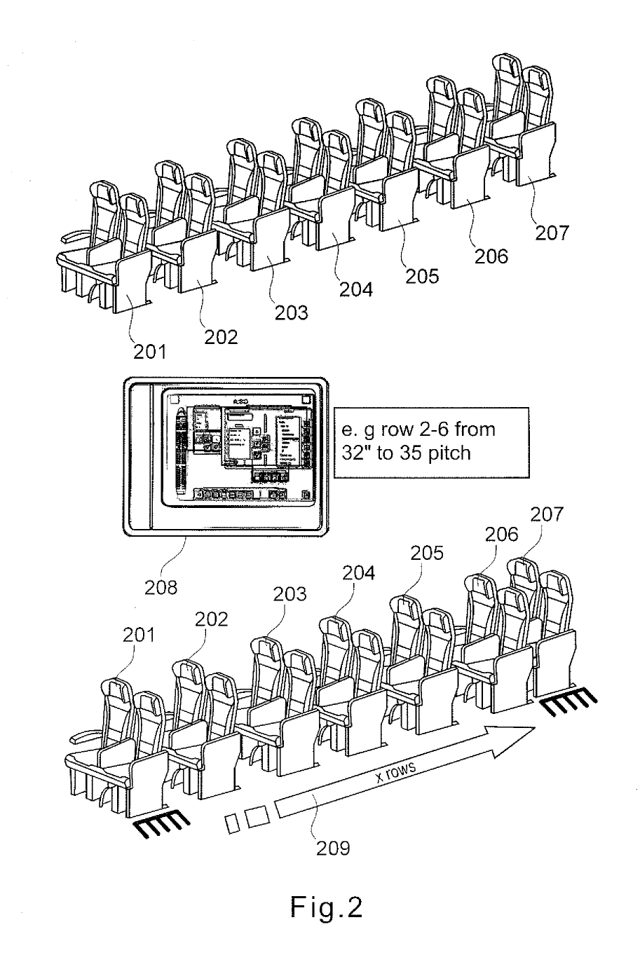

FIG. 2 shows a diagrammatic view of further seating configurations, which according to the invention are prepared automatically. Seven seat rows 201, 202, 203, 204, 205, 206 and 207 are provided, each comprising two seats that are coupled together.

The outer seats of each seat row are connected to a drive device according to the invention, which can move the individual seat rows according to seating configuration planning. Furthermore, it is possible for other seats to be connected to the drive device, e.g. the inner seats and/or the middle seats.

In order to carry out seating configuration planning, the user interface 208 is provided, which is an input unit that is, for example, accessible by the flight crew. A similar input unit can also be provided in the check-in region in the airport, by way of which input unit each passenger can set the desired legroom.

After completion of seating configuration planning, the data is transmitted to a control unit, which controls the drive device according to the seating configuration to be achieved.

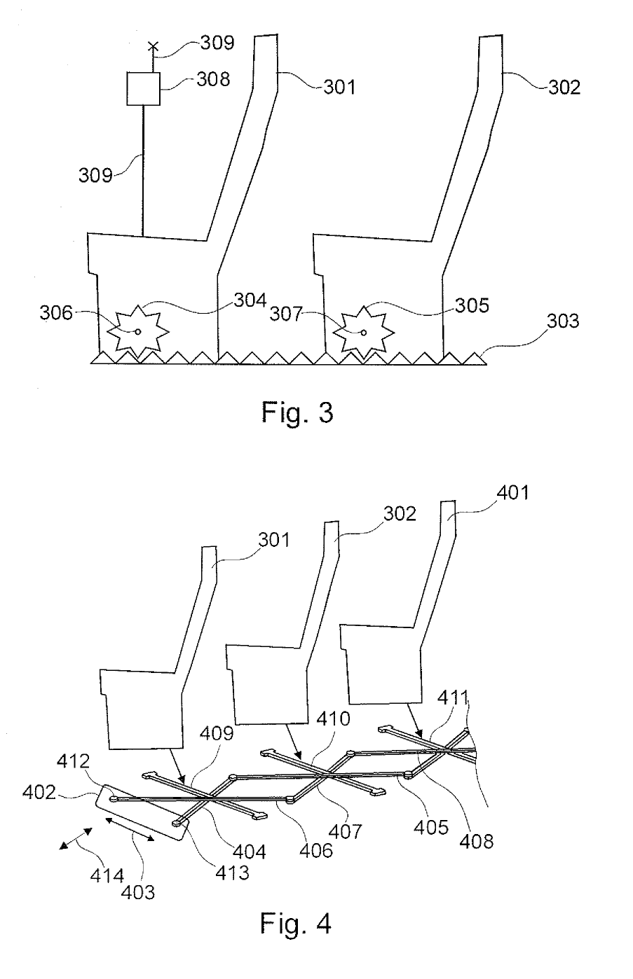

Such a control device 308 is, for example, shown in FIG. 3. The control device 308 can comprise an antenna 309 by way of which the control device 308 can receive data from the input unit 208 or from an external input unit. The control device 308 is, for example, connected to the drive unit by way of a cable connection 309.

For example, during check-in, passengers can select their desired seat on the corresponding input unit by pressing a button. Furthermore, passengers can select the desired legroom. Prior to boarding, the system will then automatically implement the desired seating configuration.

For example, an existing 15 inch seat pitch (approximately 38 cm) between the front of the seat surface of the seat 207 and the rear of the seat 206 can be reduced to 0 inch, so that each one of seat rows 202 to 206 is given a seat pitch increase of 3 inches. Movement of the seat rows 202 to 206 is indicated by the arrow 209.

This movement can take place either by means of a mechanically coupled system (e.g. scissor-type mechanism, i.e. all the rows move simultaneously) or by means of independently movable seat rows (e.g. toothed rack, drive motor and position sensors) that are controlled electronically. Depending on the concept, the system can be above floor level or below floor level (e.g. in the case of a double floor).

The seats comprise, for example, a high degree of autonomy, as a result of which the effectiveness of the system can be improved. This means that significant functions of the passenger service units, PSUs, are integrated in the seats. These are, for example, an oxygen supply or reading lights. Accordingly, the system interfaces are designed to be correspondingly flexible so that the seats can be moved.

In this way by increasing, just prior to departure, the seat pitch of the seat rows in use it is possible to provide greater passenger comfort.

FIG. 3 shows a diagrammatic view of an adjustment system with a drive device according to an exemplary embodiment of the invention. The system of FIG. 3 makes self-contained movement of the individual seat rows possible. To this effect a toothed rail or toothed rack 303 is provided. Each individual seat 301, 302 comprises a drive motor and a position sensor or rotary speed sensor. The motors and the sensors are electronically controlled, for example by way of a radio connection. The individual motors are coupled to the toothed wheels 304, 305. The toothed wheels rotate on their axes 306, 307 and in so doing move the corresponding seat 301, 302 (or the entire seat row) forwards or backwards. Guiding and locking the seats takes place in separate seat rails (not shown).

As an alternative it is also possible to provide a worm gear drive. The advantage of a worm gear drive consists of its precise and reliable adjustment of the seats.

FIG. 4 shows a diagrammatic view of a system according to a further exemplary embodiment of the invention. This is a mechanically coupled system with a scissor-type mechanism comprising individual elements 404, 405, 406, 407, 408, 409, 410 and 411. The elements 404, 405, 406, 407, 408 are coupled to each other by way of corresponding bearing arrangements in such a way that pulling or pushing the end points 412, 413 in the direction of the arrows 403 results in lengthening or shortening of the scissor-type mechanism. These elements 404 to 408 are connected to the carriers or rails 409, 410, 411 to which the seats are affixed. As a result of the shortening or lengthening of the scissor-type mechanism, movement of the seats in longitudinal direction 414 takes place.

A single drive 402 is provided that pulls apart, or pushes together, the ends 412, 413. All the seat rows move concurrently.

Depending on the concept, the systems of FIGS. 3 and 4 can be above or below floor level (e.g. double floor including system interface).

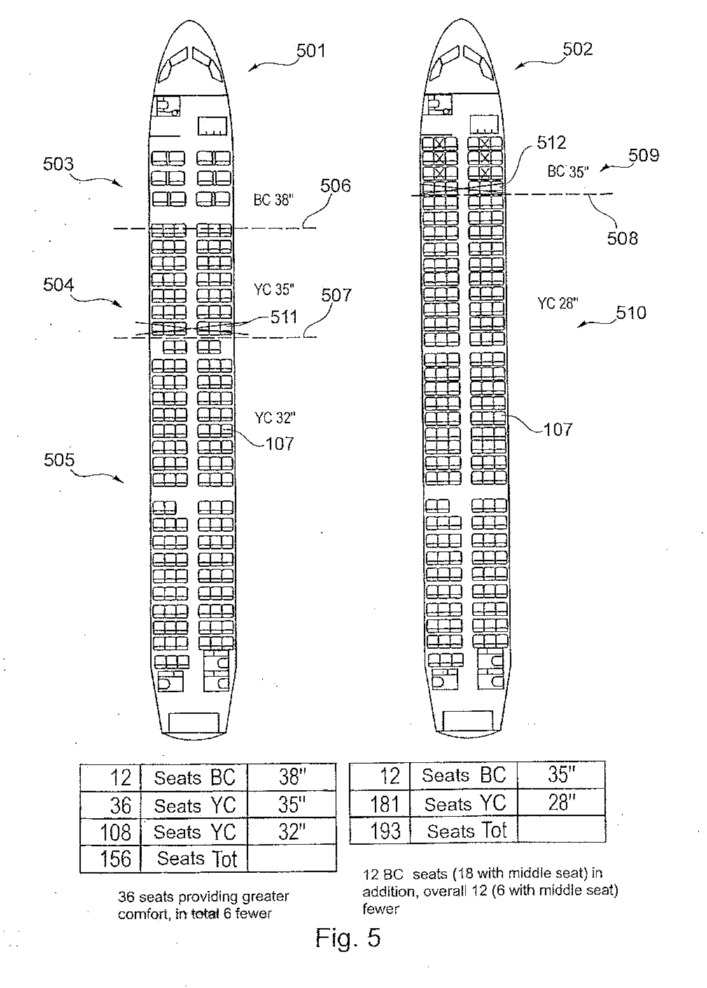

FIG. 5 shows a further diagrammatic view of two possible seat configurations 501, 502.

In the first configuration 501, in the BC region 503, which has a 38 inch seat pitch, twelve seats are arranged. In the first YC region 504, which has a 35 inch seat pitch, 36 seats are arranged.

In the second YC region 505, which has a 32 inch seat pitch, 108 seats are arranged. There are a total of 156 seats. Separation of the three regions is indicated by the dashed lines 506, 507.

Thus 36 seats with more legroom and thus with greater comfort are provided. In total there are six seats fewer than in the example 101 of FIG. 1.

Seat row 511, which corresponds to seat row 207 in FIG. 2, is not used.

In configuration 502 also twelve seats are provided in BC class 509, except with a 35 inch pitch. The seats of seat row 512 (which corresponds to seat row 207 in FIG. 2) are not used.

Furthermore, 181 seats with a 28 inch seat pitch are provided in the YC region 510.

The BC region 509 is above the dashed line 508; the YC region 510 is below the dashed line 508.

In total there are twelve BC seats (or eighteen if there are middle seats). Overall, this exemplary embodiment comprises twelve seats fewer (or six seats fewer if there are middle seats) than is the case in the exemplary embodiment 102 of FIG. 1.

The invention provides advantages in particular in that small layout changes can be implemented quickly and automatically. Furthermore, greater passenger comfort is provided (possibly as a class upgrade) when the aircraft is only partly booked.

In addition, it should be pointed out that “comprising” does not exclude other elements or steps, and “a” or “one” does not exclude a plural number. Furthermore, it should be pointed out that characteristics or steps which have been described with reference to one of the above exemplary embodiments can also be used in combination with other characteristics or steps of other exemplary embodiments described above. Reference characters in the claims are not to be interpreted as limitations.

1. A system for simultaneously longitudinally moving a plurality of selected seats or seat rows in an aircraft, with the system comprising:
a drive device for moving the seats;
wherein the system is designed for automatically moving the seats according to a change in the seating configuration planning.

2. The system of claim 1,
wherein the system is designed as a mechanically coupled system.

3. The system of claim 2,
wherein the drive device comprises a scissor-type mechanism with a single drive for all the seats.

4. The system of any one of the preceding claims,
wherein the drive device is designed for simultaneously moving all the selected seats.

5. The system of any one of the preceding claims,
wherein the system is designed for the self-contained individual moving of the selected seats or seat rows.

6. The system of claim 5,
wherein the drive device comprises a toothed rail that is fixed to the floor, and a drive motor for each seat row.

7. The system of any one of the preceding claims, further comprising:
a rotary speed sensor or a position sensor for each seat or for each seat row in order to determine a current longitudinal position of the corresponding seat or of the corresponding seat row.

8. The system of any one of the preceding claims, further comprising:
an electronic control device for controlling the drive device.

9. The system of any one of the preceding claims, further comprising:
one or several separate seat rails for guiding the seats; and
a locking device for each seat for locking the seat in the seat rail.

10. The system of any one of the preceding claims, further comprising:
an input unit for changing a seating configuration planning by a passenger;
wherein the input unit can be arranged outside the aircraft and in this case is wirelessly coupled to the control device so that said input unit is able to communicate with the control device.

11. A seating arrangement in an aircraft, with the seating arrangement comprising:
a plurality of aircraft seats; and
a system for simultaneously longitudinally moving the seats or seat rows of any one of claims 1 to 10.

12. The use of a system of any one of claims 1 to 10 in an aircraft.

13. An aircraft comprising a system of any one of claims 1 to 10.

14. A method for simultaneously longitudinally moving a plurality of selected seats or seat rows in an aircraft, with the method comprising the steps of:
planning a seating configuration;
simultaneous moving of the seats according to a change in the seating configuration planning.

15. The method of claim 14, further comprising the steps of:
transmission of the planned seating configuration from an input unit to a control unit;
automatic release of the affixation of the seats prior to moving;
automatic affixation of the seats after moving.

16. The method of claim 15,
wherein the input unit is arranged outside the aircraft.
